(19) United States
(12) Patent Application Publication
(10) Pub. No.: US 2005/0223040 A1
(43) Pub. Date: Oct. 6, 2005

(54) Facilitating searching on multicast receivers

(76) Inventor: Prasad V. Upadrasta, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/130,949

(22) Filed: May 16, 2005

Related U.S. Application Data
(62) Division of application No. 09/613,323, filed on Jul. 11, 2000.

(51) Int. Cl. G06F 7/00

(52) U.S. Cl. 707/104.1

(57) ABSTRACT

By providing an index table with content pushed through a multicast system to a plurality of processor-based systems, searching for content on the receiving processor-based systems is facilitated. The receiving processor-based systems may parse the index table from the content and may accumulate the index tables to facilitate keyword searching through the index tables.

### BACKGROUND

This invention relates generally to multicasting information through a broadband medium to a plurality of receivers.

A broadband server may multicast selected information to a plurality of receivers. Each of these receivers may be coupled to the server through a broadband connection. For example, the receivers and the server may be coupled over the Internet. Each of the receivers may be able to receive a relatively high data rate of information. Thus, information may be pushed from the broadband server to the receivers.

The receivers may designate the types of information they wish to receive. Thereafter, the broadband server may push the selected information to the receiver at regular intervals. For example, a given receiver may receive information about national news events relating to technology topics.

Eventually, a receiver may have so much information that it becomes difficult, even within the requested categories, for the user of the receiver to locate information of interest. That is, a server may push information at regular intervals to a receiver so that over time a considerable database of information may be stored by the receiver. Then, when the user of the receiver wishes to find a particular piece of information, it is relatively difficult to do so.

Within any given document, the find function on some browsers may be utilized to conduct limited searches through the document. However, the ability to search through a wide range of documents pushed over time to the receiver may be limited. While software may be available that enables an index table to be developed on the receiver, such software involves a large number of machine instructions and may tie up the receiver's resources.

Thus, there is a need for better ways to enable multicast receivers to search for information pushed to the receivers by a broadband server.

### BRIEF DESCRIPTION OF THE DRAWINGS

FIG. 1 is a schematic depiction of one embodiment of the present invention;

FIG. 2 is a flow chart for software on a processor-based system to facilitate searching of multicast data;

FIG. 3 is a flow chart for software on a multicast receiver in accordance with one embodiment of the present invention;

FIG. 4 is a flow chart for software on the broadband server in accordance with one embodiment of the present invention;

FIG. 5 is a flow chart for software on the server in accordance with another embodiment of the present invention;

FIG. 6 is a flow chart for software on the receiver in accordance with still another embodiment of the present invention; and

FIG. 7 is a flow chart for software on the server in accordance with the embodiment shown in FIG. 6.

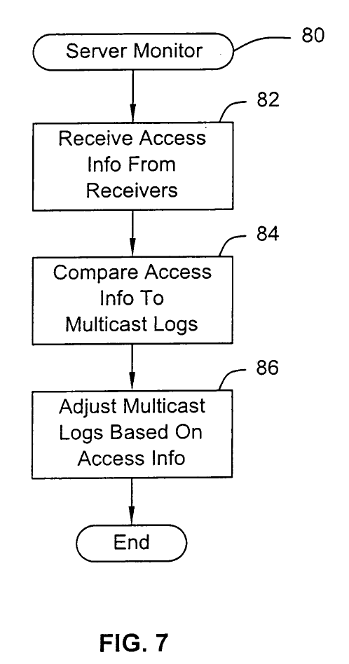

### DETAILED DESCRIPTION

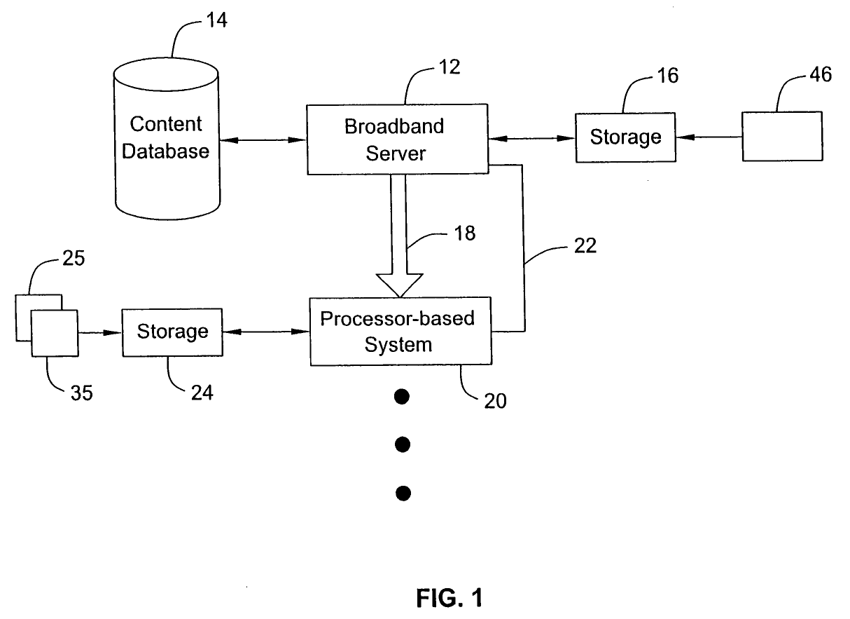

Referring to FIG. 1, a broadband server 12 may be coupled to a plurality of processor-based systems 20 over a transport medium 18. In one embodiment of the present invention, the broadband server 12 provides the information to a plurality of processor-based systems 20 coupled over the Internet by broadband access services such as satellite, cable or digital subscriber line (DSL) as examples. The processor-based systems 20 may be any processor-based system including a computer system with a storage 24 to store information pushed by the broadband server 12 to the processor-based system 20.

The broadband server 12 may include a content database 14 that may be repetitively searched for information falling into certain categories. Moreover, the broadband server 12 may offer for selection a plurality of categories of information. Thus, each processor-based system 20 may request that the serve 12 push information that falls in certain categories to the processor-based system 20. Any processor-based system 20 may provide a request, for example over the back channel 22, for a particular category of information. Then when information in that category comes to the server 12, it may be identified and passed to the processor-based system 20 without any further request. The technology for providing categories of information to receiver continually without a renewed request is referred to herein as push technology.

The broadband server 12 may also include a storage 16 that stores software 46 that may be useful in controlling its operations. Conventionally, the broadband server 12 is also a processor-based system.

The processor-based system 20 and its storage 24 may store content received from the broadband server 12. In addition, the storage 24 may store software 25 and 35 that is useful in controlling the processor-based system 20 and enabling it to operate as an effective receiver of the content pushed by the broadband server 12 to the system 20.

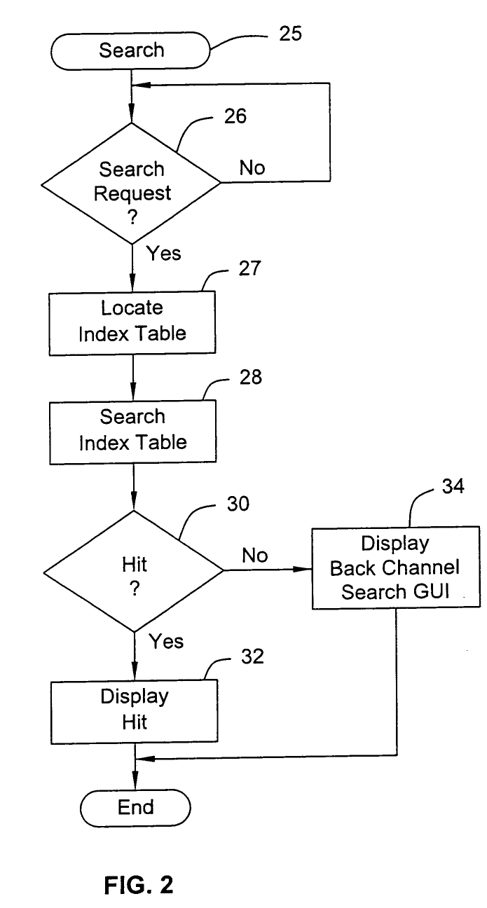

Referring next to FIG. 2, the software 25 stored in the storage 24 begins by determining whether a user initiated search request has been received as an input command, in accordance with one embodiment of the present invention. If a search request has been received, as indicated at diamond 26, the software 25 locates an index table as indicated in block 27. An index table is a table that references certain key words to content pushed by the broadband server 12. The index table may normally be provided by the broadband server 12 together with the content in the requested categories.

After the processor-based system 20 has located the index table, it searches the index table to find words that match the keywords submitted by the user as indicated in block 28. If a hit is identified, as indicated in diamond 30, the hit information is displayed as indicated in block 32. For example, the information may be displayed in a summary or capsule format on a display coupled to the processor-based system 20.

Conversely, if a hit is not identified, a graphical user interface may be displayed on a display, as indicated in block 34. The interface may afford the option to conduct a search over the Internet, for example by way of the back channel 22 as one example. Of course, the search may also be submitted over the transport medium 18 in another embodiment.

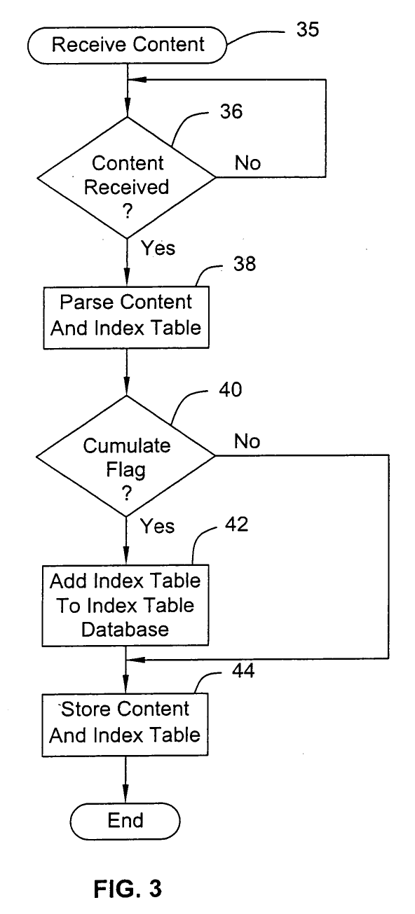

Turning now to FIG. 3, the process of receiving the information is illustrated in connection with the software 35 in accordance with one embodiment of the present invention. When content and index table is received over the transport 18, as determined in diamond 36, the content is parsed from the index table (block 38) provided by the broadband server 12. The user may select to accumulate the index tables received with each transmission from the broadband server 12 to create a unified, searchable index table. Alternatively, the user may prefer to search the index table for each push session; that is, to search within the content provided with a given transmission from the broadband server 12.

If the user wishes to accumulate the index tables, the user sets a flag, identified at diamond 40 in accordance with one embodiment of the present invention. The new index table is then added to an index table database, as indicated in block 42. If the user has so set the flag, the index table provided with the content is added to the existing index table database built up over time from other push content received from the broadband server 12. Thereafter, the content that has just been received and the new index table are stored as indicated in block 44.

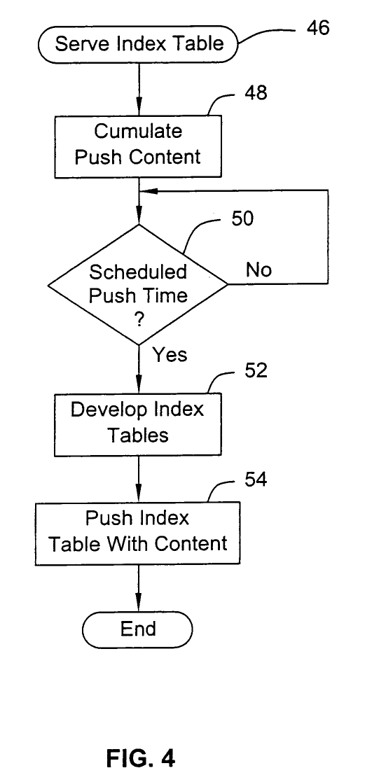

The broadband server 12 may use the software 46, shown in FIG. 4, in accordance with one embodiment of the present invention. The server 12 continually accumulates and searches for categories of content to push to the processor-based systems 20 as indicated in block 48. When it finds sufficient information in one or more categories requested by processor-based systems 20, the server 12 may push that information to the processor-based systems 20.

Alternatively, when a scheduled push time arrives, as indicated in diamond 50 the server 12 may prepare to push whatever content it has accumulated up to that instance to the receiving processor-based systems 20. However, before pushing the content, the server 12 may develop the index table for the information about to be pushed to the processor-based systems 20, as indicated in block 52. Thereafter, the index table with the content may be pushed over the transport 18 to the requesting processor-based systems 20, as indicated in block 54.

By developing the index tables on the server 12 for all of the requesting processor-based systems 20, a more efficient system is achieved. This efficiency arises because each processor-based system 20 need not independently undergo the duplicative process of developing the index table from the information provided by the server is 12. Instead, the server 12 may compile the index table at one time for all the requesting processor-based systems 20. This facilitates searching on the processor-based systems 20 since a search may be implemented more quickly after the content is pushed from the server 12. Moreover, the processing power of each processor-based system 20 is not needlessly tied up in developing index tables.

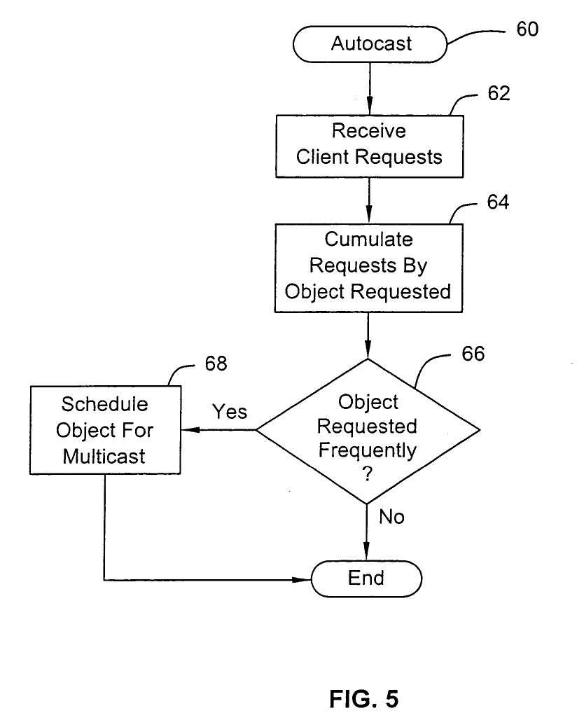

The autocast software 60, shown in FIG. 5, may be resident on the storage 16 associated with the broadband server 12. Initially, the software 60 receives client requests for content as indicated in block 62. Those requests may be accumulated and organized by the content requested as indicated in block 64. Based on this organization, the server gets feedback on what information is needed at one or more processor-based systems 20. When it is determined that a particular object or content is requested frequently, as determined in diamond 66, that object may be scheduled for multicast in the next upcoming multicast from the server 12 to the systems 20.

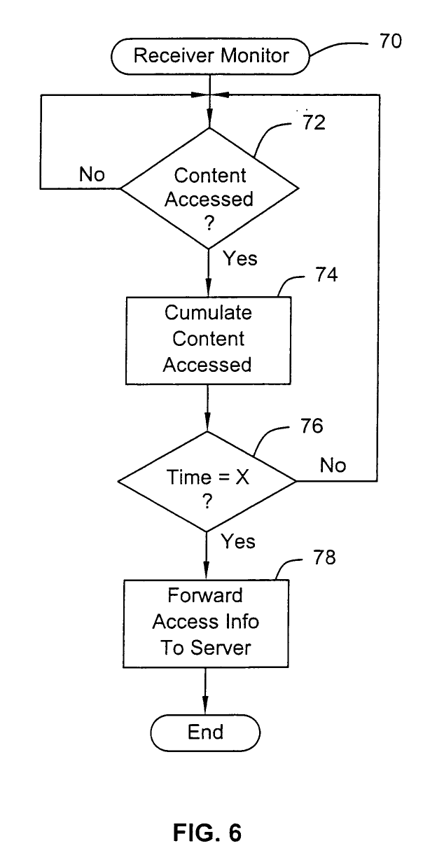

Referring next to FIG. 6, the receiver monitor software 70 may be resident on the storage 24 of a processor-based system 20. Initially, the software 70 determines whether content has been accessed on the processor-based system 20, as indicated in diamond 72. If so, the content access is accumulated as indicated in block 74. In other words, the nature of the content accessed may be determined and a count incremented to indicate how often that content is actually accessed.

A check at diamond 76 determines whether a predetermined time period has arrived. If not, the flow iterates. Otherwise, the accumulated access information on the processor-based system 20 is automatically transmitted to the broadband server 12, for example over the back channel 22, as indicated in block 78.

The server monitor software 80, resident on the storage 16 associated with the broadband server 12, receives the access information from one or more systems 20 as indicated in block 82. The access information is then compared to multicast logs that list the content intended to be transmitted to the various processor-based systems 20, as indicated in block 84. The multicast logs may then be adjusted based on the access information as indicated in block 86. As a result, the information that is broadcast is fine tuned to account for what is actually being used on the processor-based systems 20.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1-30. (canceled)

31. A method comprising:
determining the content which is accessed in a receiver;
accumulating information about the content accessed on a receiver; and
periodically forwarding said information to a server.

32. The method of claim 31 including receiving on said receiver periodic push transmissions of the content from said server.

33. A method comprising:
receiving on a server, client requests for content;
accumulating said requests for content;
determining whether particular content is requested frequently by a client; and
adjusting the content transmitted to said client based on the frequency of requests for content by said client.

34. The method of claim 33 including scheduling content for transmission by multicast to said client in response to a given number of requests for the particular content.

35. A method comprising:
receiving information from receivers about the frequency with which content on said receivers is accessed;
comparing the access information from the receivers to information about content to be transmitted by a server to said receivers; and
adjusting the content transmitted to said receivers based on said access information.

36. The method of claim 35 including scheduling content for transmission by multicast to at least one of said receivers in response to the frequency information.

37. The method of claim 35, wherein the access information is compared to one or more multicast logs.

38. The method of claim 31 wherein said information is periodically forwarded to said server via a back channel.

39. The method of claim 34 including forwarding said scheduled content via a back channel to said client.

40. A system comprising:
a server, wherein said server to receive client requests for content, to accumulate the requests for content, to determine whether particular content is requested frequently by a client, and to adjust the content to be transmitted to the client based on the frequency of requests for content by the client.

41. The system of claim 40 wherein said server to schedule content for transmission by multicast to the client in response to the frequency information.

42. The system of claim 41 wherein said server to forward the scheduled content via a back channel to the client.

43. A system comprising:
a receiver, wherein said receiver to determine content which is accessed in said receiver, to accumulate information about the content accessed on said receiver, and to periodically forward the information to a server.

44. The system of claim 43 wherein said receiver to receive periodic push transmissions of the content from the server.

45. The system of claim 43 wherein said information is periodically forwarded to the server via a back channel.

46. A system comprising:
a server, wherein said server to receive information from one or more receivers about the frequency with which content on the one or more receivers is accessed, to compare the access information from the one or more receivers to information about content to be transmitted by said server to at least one of the one or more receivers, and to adjust the content transmitted to the at least one of said receivers based on the access information.

47. The system of claim 46 wherein said server to schedule content for transmission by multicast to at least one of the receivers in response to the frequency information.

48. The system of claim 46, wherein the access information is compared to one or more multicast logs.
